(19) United States
(12) Patent Application Publication
(10) Pub. No.: US 2025/0216623 A1
(43) Pub. Date: Jul. 3, 2025

(54) INTERPOSER HAVING INTEGRATED OPTICAL WAVEGUIDE

(71) Applicant: QUALCOMM Incorporated, San Diego, CA (US)

(72) Inventors: Ranadeep DUTTA, Del Mar, CA (US); Jonghae KIM, San Diego, CA (US); Je-Hsiung LAN, San Diego, CA (US)

(21) Appl. No.: 18/403,136

(22) Filed: Jan. 3, 2024

(51) Int. Cl. G02B 6/42; G02B 6/02; G02B 6/43

(52) U.S. Cl. CPC G02B 6/4201; G02B 6/02; G02B 6/43

(57) ABSTRACT

An interposer has a first side and a second side and includes an optical waveguide defined in a region between the first side and the second side. The interposer also includes first contacts on the first side configured to be electrically connected to one or more electronic devices, and second contacts on the second side configured to be electrically connected to one or more photonic devices. The interposer also includes conductive interconnects electrically connecting one or more of the first contacts to one or more of the second contacts. The interposer also includes an optical coupler on the second side configured to enable coupling of light between the one or more photonic devices and the optical waveguide.

### FIELD

Various features relate to an interposer having an optical waveguide integrated therein.

### BACKGROUND

Advances in technology have enabled manufacture of semiconductor devices that are thinner and have a smaller form factor than previous generations of devices while often providing higher performance, lower power demand, or both. Such advances increasingly drive improvements in related technologies, such as battery technologies and packaging technologies. For example, semiconductor technology advances generally result in dies that have more complex circuitry (e.g., transistors) per unit area, finer line widths, narrower line spacing, thinner layers, etc. Dies with more complex circuitry often have an increased need for input/output (I/O) connections; however, there is often also an expectation that packaged devices with more advanced dies have the same or smaller form factor as prior generations of devices.

Packaging technologies have advanced to address these conflicting demands. For example, for the most demanding applications, more traditional wire bond packaging technologies have largely been replaced by flip chip technologies. Using flip chip technologies, most or all of one surface of a die can be used for I/O connections, providing a significant increase over wire bond packaging. However, using flip chip technologies introduces additional challenges. For example, flip chip devices typically have a large number of I/O connections in a relatively small area. Because of the small available area, the metal traces used to interconnect two flip chip devices are generally narrow. Long, narrow traces can introduce significant losses leading to challenges interconnecting flip chip devices that are distant from one another.

### SUMMARY

Various features relate to interposers.

One example provides a device that includes an interposer having a first side and a second side. The interposer includes an optical waveguide defined in a region between the first side and the second side. The interposer also includes first contacts on the first side configured to be electrically connected to one or more electronic devices, and second contacts on the second side configured to be electrically connected to one or more photonic devices. The interposer also includes conductive interconnects electrically connecting one or more of the first contacts to one or more of the second contacts. The interposer also includes an optical coupler on the second side configured to enable coupling of light between the one or more photonic devices and the optical waveguide.

Another example provides an integrated device that includes an interposer having a first side and a second side. A first electronic device is coupled to the first side of the interposer, and a second electronic device is coupled to the first side of the interposer. A first photonic device is coupled to the second side of the interposer, and a second photonic device is coupled to the second side of the interposer. The interposer includes an optical waveguide defined in a region between the first side and the second side. The interposer also includes first conductive interconnects electrically connecting the first electronic device and the first photonic device, and second conductive interconnects electrically connecting the second electronic device and the second photonic device. The interposer includes a first optical coupler on the second side configured to enable coupling of light between the first photonic device and the optical waveguide. The interposer also includes a second optical coupler on the second side configured to enable coupling of light between the second photonic device and the optical waveguide.

Another example provides a method for fabricating a device. The method includes forming a body defining an optical waveguide. The body includes a first layer having a first refractive index, a second layer having a second refractive index, and a third layer between the first layer and the second layer. The third layer has a third refractive index that is greater than the first refractive index and greater than the second refractive index. The method includes forming a plurality of conductive interconnects through the body to electrically connect first contacts on a first side of the body to second contacts on a second side of the body. The method also includes arranging one or more optical couplers on the second side of the body to couple light between the third layer and one or more photonic devices.

Another example provides a method that includes sending a first electrical signal from a first electronic device to a first photonic device via one or more first conductive interconnects that extend through a body of an interposer. The method also includes generating a light signal, based on the first electrical signal, at the first photonic device. The method further includes routing the light signal, via an optical coupler, to an optical waveguide defined in the body of the interposer. The method also includes receiving the light signal at a second photonic device coupled to the interposer. The method further includes sending a second electrical signal, based on the light signal, from the second photonic device to a second electronic device via one or more second conductive interconnects that extend through the body of the interposer.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1A illustrates a schematic top view of an example of a device that includes an interposer defining an integrated optical waveguide.

FIG. 1B illustrates a schematic cross-sectional view of the device of FIG. 1A.

FIG. 2A illustrates a schematic cross-sectional view of an example of a device that includes an interposer defining an integrated optical waveguide.

FIG. 2B illustrates a schematic top view of the device of FIG. 2A.

FIG. 3A illustrates a schematic cross-sectional view of an example of a device that includes an interposer defining an integrated optical waveguide.

FIG. 3B illustrates a schematic top view of the device of FIG. 3A.

FIGS. 4A and 4B, together, illustrate an exemplary sequence for fabricating a device that includes an interposer defining an integrated optical waveguide.

FIG. 5 illustrates an exemplary flow diagram of a method for fabricating a device that includes an interposer defining an integrated optical waveguide.

FIG. 6 illustrates an exemplary flow diagram of a method of operation of a device that includes an interposer defining an integrated optical waveguide.

FIG. 7 illustrates various electronic devices that may integrate a die, an electronic circuit, an integrated device, an interposer defining an integrated optical waveguide, a passive component, a package, and/or a device package described herein.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features and are subsequently referred to in the singular or optional plural (as indicated by “(s)”) unless aspects related to multiple of the features are being described.

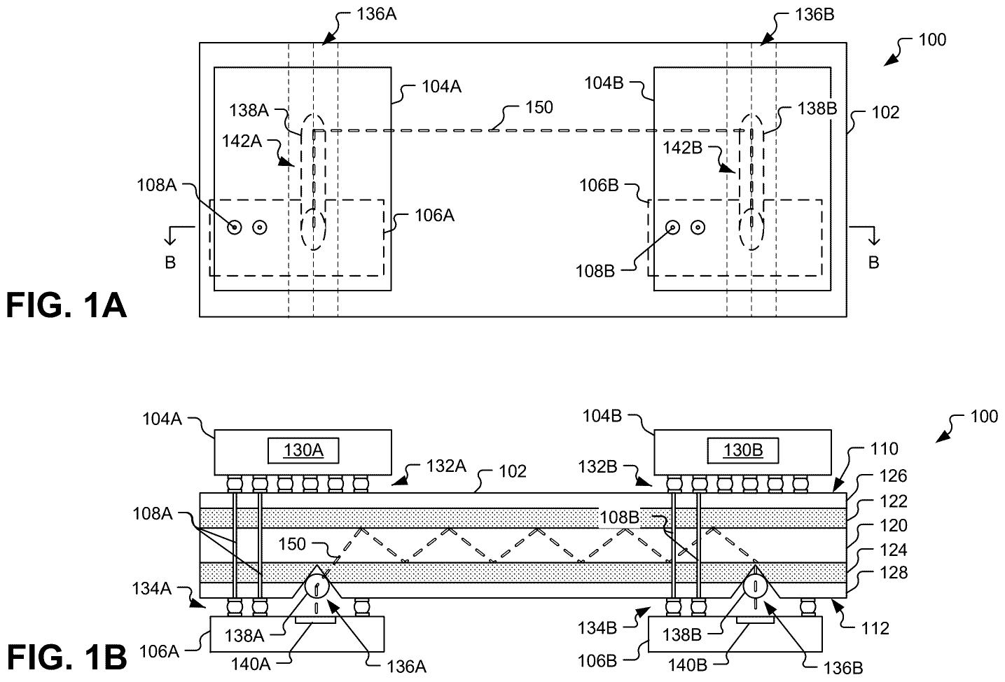

In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1B, multiple instances of electronic devices 104 are illustrated and associated with reference numbers 104A and 104B. When referring to a particular one of these electronic devices, such as a first electronic device 104A, the distinguishing letter “A” is used. However, when referring to any arbitrary one of these electronic devices or to these electronic devices as a group, the reference number 104 is used without a distinguishing letter.

As used herein, the terms “comprise,” “comprises,” and “comprising” may be used interchangeably with “include,” “includes,” or “including.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

Improvements in manufacturing technology and demand for lower cost and more capable electronic devices has led to increasing complexity of integrated circuits (ICs). Often, more complex ICs have more complex interconnection schemes to enable interaction between ICs of a device. The number of interconnect levels for circuitry has substantially increased due to the large number of devices that are now interconnected in a state-of-the-art mobile application device.

These interconnections include back-end-of-line (BEOL) interconnect layers, which may refer to the conductive interconnect layers for electrically coupling to front-end-of-line (FEOL) active devices of an IC. The various BEOL interconnect layers are formed at corresponding BEOL interconnect levels, in which lower BEOL interconnect levels generally use thinner metal layers relative to upper BEOL interconnect levels. The BEOL interconnect layers may electrically couple to middle-of-line (MOL) interconnect layers, which interconnect to the FEOL active devices of an IC. As used herein, the term “layer” includes a film, and should not be construed as indicating a vertical or horizontal thickness unless otherwise stated.

While the use of complex interconnected layer arrangements can enable interconnection of electronic devices with large numbers of I/O connections, the conductors interconnecting these electronic devices tend to get longer (e.g., due to being routed through more layers) and/or thinner (e.g., to enable routing of more traces in a given area) as the number of interconnects to be routed increases. Longer and/or thinner traces can introduce various problems. For example, longer and/or thinner traces are associated with higher losses.

According to a particular aspect, one or more optical waveguides are integrated within an interposer. In particular, the optical waveguide(s) are defined in structural components of the interposer (e.g., layers that form a body of the interposer), as distinct from, for example, optical fibers or similar devices attached to portions of an interposer. As an example, the interposer can have a layered structure including cladding layers on either side of a core layer. In this example, the refractive indexes of the layers are arranged such that the refractive index of the core layer is greater than the refractive indexes of the cladding layers, enabling light to propagate within the core layer. The interposer can also include various electrical interconnects, such as redistribution layers, metal traces, through vias, etc.

In some embodiments, an optical waveguide defined in the layers of the interposer can be used to facilitate communication between two or more electronic devices coupled to the interposer. For example, a first electronic device can be coupled to a first side of the interposer, and a first photonic device can be coupled to a second side of the interposer and electrically connected to the first electronic device by one or more conductive interconnects (e.g., conductive through vias) of the interposer. In this example, the first electronic device can send electrical signals, via the conductive interconnect(s) to the first photonic device. The first photonic device can generate light signals based on the electrical signals and introduce the light signals into the optical waveguide by way of an optical coupler. Another device (e.g., a second photonic device coupled to the interposer) can receive the light signals from the optical waveguide. To illustrate, the second photonic device can receive the light signals, via a second optical coupler, and generate electrical signals based on the light signals. In some embodiments, the second photonic device can be electrically connected to a second electronic device (e.g., by the conductive interconnect(s) of the interposer), and the second photonic device can provide the electrical signals representing the light signals to the second electronic device. Thus, the first and second electronic devices can communicate with one another by way of light signals propagated through the optical waveguide. One technical benefit of this arrangement is that light signals transmitted through the optical waveguide have lower transmission losses than would be suffered by electrical signals transmitted over the same distance via typical metal traces. Additionally, forming the optical waveguide into the body of the interposer simplifies integration of optical and electronic components in a single device, thereby increasing yield and decreasing cost.

### Exemplary Devices Including Interposers Defining Integrated Optical Waveguides

FIG. 1A illustrates a schematic top view of a device 100. FIG. 1B illustrates a schematic cross-sectional view of the device 100 of FIG. 1A along a cutline BB. The device 100 includes an interposer 102 that includes a core layer 120 and cladding layers 122, 124 on opposing sides of the core layer 120 to define an optical waveguide. The interposer 102 also includes conductive interconnects 108 that extend through the layers 120-124 to electrically connect one or more devices on a first side 110 of the interposer 102 to one or more devices on a second side 112 of the interposer 102.

The example illustrated in FIGS. 1A and 1B shows a first electronic device 104A and a second electronic device 104B coupled to the first side 110 of the interposer 102, and a first photonic device 106A and a second photonic device 106B coupled to the second side 112 of the interposer 102. In this example, the first electronic device 104A is electrically connected to the first photonic device 106A via contacts 132A, conductive interconnects 108A, and contacts 134A. Similarly, the second electronic device 104B is electrically connected to the second photonic device 106B via contacts 132B, conductive interconnects 108B, and contacts 134B.

The electronic devices 104 include circuitry 130 configured to exchange signals, via the interposer 102. For example, circuitry 130A of the first electronic device 104A can send signals to and/or receive signals from circuitry 130B of the second electronic device 104B, as described in more detail below. The circuitry 130 of the devices 104 can include, for example, power management integrated circuits (PMICs), one or more logic circuits (e.g., an application processor, a digital signal processor, a graphics processor, etc.), one or more memory circuits (e.g., Dynamic Random-Access Memory (DRAM) circuitry), one or more communication circuits (e.g., a modem, a radio frequency (RF) device, a transmitter, a receiver, etc.), or other types of semiconductor-based integrated circuits. Components of the circuitry 130 can include, for example, different types of transistors, such as a field effect transistor (FET), planar FET, finFET, a gate all around FET, or mixtures of transistor types. In some implementations, a front end of line (FEOL) process may be used to fabricate the circuitry 130 in and/or over the semiconductor substrate. As a semiconductor-based integrated circuit, the circuitry 130 is formed in or on a semiconductor material, such as silicon, silicon carbide, gallium arsenide, gallium nitride, germanium, etc.

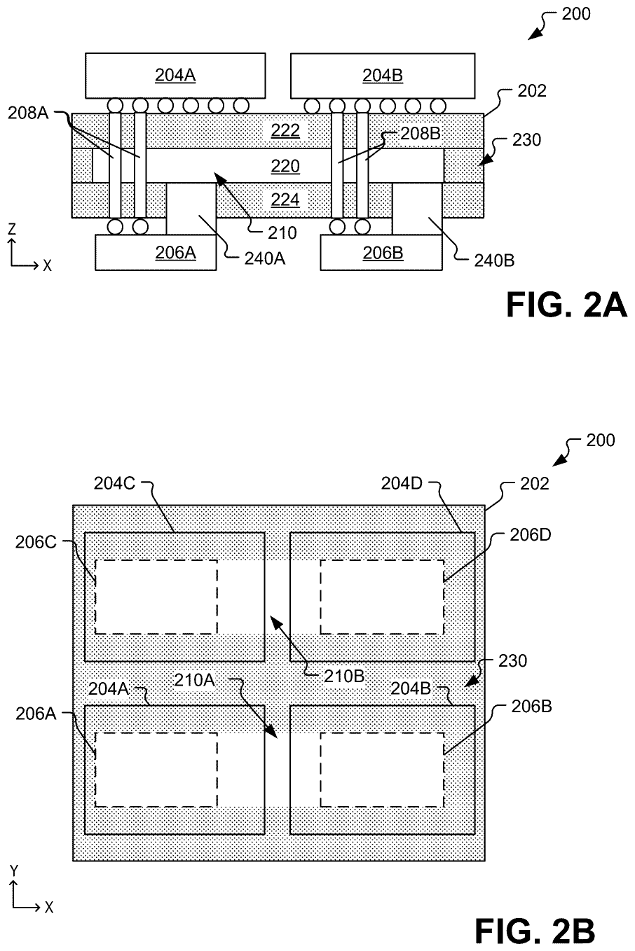

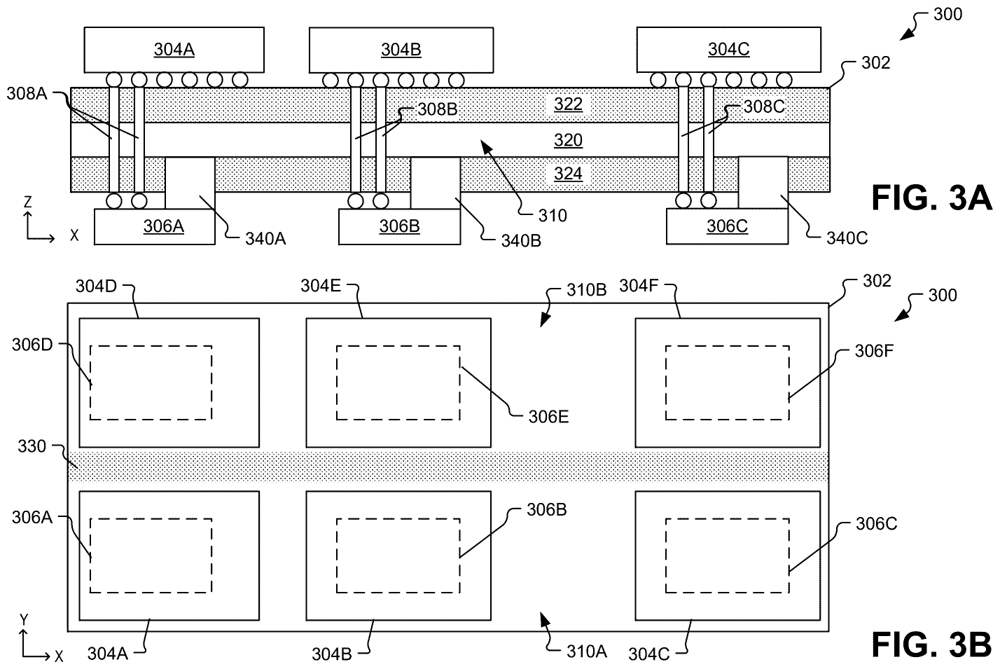

The core layer 120 and cladding layers 122, 124 together define an optical waveguide in a region within a body of the interposer 102. For example, in FIGS. 1A and 1B, most or all of the core layer 120 has a single refractive index (which is greater than refractive indexes of the cladding layers 122, 124) thereby enabling substantially the entire core layer 120 to operate as a planar waveguide in which light signals 150 can propagate via total internal reflection. In other examples, the core layer 120 can include regions with different refractive indexes (e.g., as illustrated in FIGS. 2A and 2B and in FIGS. 3A and 3B), in which case the interposer 102 can define two or more separate optical waveguides.

Optionally, the interposer 102 can include one or more redistribution layers 126 on the first side 110, one or more redistribution layers 128 on the second side 112, or both. For example, power, ground, and/or signals can be provided to one or more of the electronic devices 104 via traces of the redistribution layer(s) 126. Additionally, or alternatively, power, ground, and/or signals can be provided to one or more of the photonic devices 106 via traces of the redistribution layer(s) 128. As another example, the device 100 can include one or more additional electronic devices that are coupled to the first electronic device 104A, to the second electronic device 104B, or to both, via traces of the redistribution layer(s) 126. Additionally, or alternatively, the device 100 can include one or more additional electronic devices that are coupled to the first photonic device 106A, to the second photonic device 106B, or to both, via traces of the redistribution layer(s) 128.

Each of the photonic devices 106 include circuitry 140 to generate light signals based on electrical signals, to generate electrical signals based on light signals, or both. For example, circuitry 140A of the first photonic device 106A can include one or more lasers, one or more light emitting diodes, or other solid-state light emitting devices to generate the light signals 150 based on electrical signals received from the first electronic device 104A. In this example, circuitry 140B of the second photonic device 106B can include one or more photodiodes, or other solid-state light detection devices to generate electrical signals based on the light signals 150 and to provide the electrical signals to the second electronic device 104B. Additionally, or alternatively, the circuitry 140B of the second photonic device 106B can include one or more lasers, one or more light emitting diodes, or other solid-state light emitting devices to generate the light signals 150 based on electrical signals received from the second electronic device 104B, and the circuitry 140A of the first photonic device 106A can include one or more photodiodes or other solid-state light detection devices to generate electrical signals based on the light signals 150 and to provide the electrical signals to the first electronic device 104A.

In some embodiments, one or more of the photonic devices 106 is associated with an optical coupler 142 to facilitate communication of the light signals 150 between the photonic device 106 and the core layer 120. For example, the first photonic device 106A is associated with an optical coupler 142A, and the second photonic device 106B is associated with an optical coupler 142B. In the example illustrated in FIGS. 1A and 1B, the optical coupler 142A includes an optical fiber 138A disposed in a groove 136A or recess on the second side 112 of the body of the interposer 102, and the optical coupler 142B includes an optical fiber 138B disposed in a groove 136B or recess on the second side 112 of the body of the interposer 102. In this example, the optical fibers 138 associated with a photonic device 106 can include a first faceted end arranged to capture and internally propagate light from the photonic device 106 to a second faceted end that is arranged to emit light into the core layer 120 at an angle appropriate to initiate total internal reflection of the light signals 150. The second faceted end can also receive the light signals 150 from the core layer 120 and propagate the light signals 150 to the first faceted end, where the first faceted end is arranged to direct the light toward the circuitry of the photonic device 106. This arrangement of faceted optical fibers 138 in grooves 136 on the second side 112 of the interposer 102 may be used in conjunction with couplers, such as edge couplers, spot size converters, or grating couplers, to couple the light into the waveguide; however, in other embodiments, other types of optical couplers 142 can be used.

To enable propagation of the light signals 150 (e.g., via total internal reflection) the core layer 120 has a refractive index that is higher than a refractive index of the cladding layer 122 and is higher than a refractive index of the cladding layer 124. In some embodiments, the refractive indexes of the cladding layers 122, 124 are substantially equal; however, in other embodiments, the refractive indexes of the cladding layers 122, 124 can be different from one another. For example, since the light signals 150 in the arrangement illustrated in FIG. 1B are always introduced into the core layer 120 from the bottom, the refractive index of the cladding layer 124 can be selected, in part, to facilitate exchange of the light signals 150 with the optical couplers 142.

In some embodiments, the layers 120-124 of the body of the interposer 102 are formed separately and subsequently affixed to one another. For example, each of the layers 120-124 can be formed as a distinct material specimen having an appropriate refractive index (and possibly other characteristics, such as thickness) for the corresponding layer 120-124 and the distinct material specimens can be stacked and affixed to one another to form the body of the interposer 102. To illustrate, each of the layers 120-124 can include a silicon-based material, such as crystalline silicon, poly-silicon, silicon nitride, doped silicon, etc. and chemical and/or physical properties of the specimens of the silicon-based material can be controlled to provide a target refractive index associated with each layer 120-124.

As one example, the refractive indexes can be established by controlling the porosity of the material of each layer 120-124. To illustrate, the cladding layer 122 can include a first material (e.g., Si, SiN, one or more dopants, etc.) having a first porosity that provides the first material a first refractive index, the cladding layer 124 can include a second material (which can have the same or different chemical constituents as the first material of the cladding layer 122) having a second porosity that provides the second material a second refractive index, and the core layer 120 can include a third material (which can have the same or different chemical constituents as the first material of the cladding layer 122 and/or the second material of the cladding layer 124) having a third porosity that provides the third material a third refractive index. To illustrate, the refractive index of silicon decreases as porosity increases, and to facilitate propagation of the light signals 150, the cladding layers 122, 124 should have a lower refractive index than the core layer 120. Therefore, in the example above, the third material of the core layer 120 can have a lower porosity than the first material of the cladding layer 122 and can have a lower porosity than the second material of the cladding layer 124.

In addition to, or instead of, controlling the refractive indexes of the layers 120-124 based on porosity of their respective materials, the layers 120-124 can include chemical constituents that establish their porosities. For example, one or more of the layers 120-124 can include a dopant (referred to herein as a “refractive index dopant” to indicate that the target effect of the dopant is control of refractive index of the material) that affects the refractive index of the layer 120-124. As another example, the layers 120-124 can be formed of different materials. To illustrate, the core layer 120 can include porous silicon nitride (SiN) and the cladding layers 122, 124 can include porous silicon (Si).

FIGS. 2A and 2B illustrate aspects of a device 200, which is a particular example of the device 100 of FIGS. 1A and 1B. FIG. 2A illustrates a schematic cross-sectional view of the device 200, and FIG. 2B illustrates a schematic top view of the device 200 of FIG. 2A. The device 200 includes an interposer 202 that includes a core layer 220 and cladding layers 222, 224 on opposing sides of the core layer 220 to define optical waveguides 210. The interposer 202 also includes electrical interconnects 208 that extend through the layers 220-224 to electrically connect electronic devices 204 on a first side of the interposer 202 to photonic devices 206 on a second side of the interposer 202.

In the example illustrated in FIGS. 2A and 2B, the electronic devices 204 include a first electronic device 204A, a second electronic device 204B, a third electronic device 204C, and a fourth electronic device 204D. Further, in FIGS. 2A and 2B, the photonic devices 206 include a first photonic device 206A, a second photonic device 206B, a third photonic device 206C, and a fourth photonic device 206D. The electronic devices 204 of FIGS. 2A and 2B are examples of the electronic devices 104 of FIGS. 1A and 1B, and the photonic devices 206 are examples of the photonic devices 106 of FIGS. 1A and 1B.

In FIGS. 2A and 2B, each of the photonic devices 206 is associated with an optical coupler 240 to facilitate communication of light signals between the photonic device 206 and the optical waveguide 210 defined in the core layer 220. For example, the first photonic device 206A is associated with an optical coupler 240A, and the second photonic device 206B is associated with an optical coupler 240B. In some implementations, the optical couplers 240 include optical fibers disposed in grooves or recesses of the interposer 202 in conjunction with edge couplers, spot size converters or grating couplers configured to facilitate exchange of light signals between the photonic devices 206 and the optical waveguides 210. In other examples, other types of optical couplers 240 are used.

In FIGS. 2A and 2B, the core layer 220 and cladding layers 222, 224 together define the optical waveguides 210 within a body of the interposer 202. For example, regions of the core layer 220 corresponding to each optical waveguide 210 has a refractive index greater than refractive indexes of the cladding layers 222, 224. Further, in FIGS. 2A and 2B, other regions 230 of the core layer 220 have a lower refractive index than the regions corresponding to the optical waveguides 210, thereby distinguishing two or more separate optical waveguides 210 (e.g., optical waveguide 210A and optical waveguide 210B, as shown in FIG. 2B) within the interposer 202. The regions 230 can be viewed as walls within the core layer 220 that separate the two or more optical waveguides 210. Optionally, the regions 230 can separate ends and/or sides of the core layer 220 to limit leakage of the light signals outside the interposer 202.

Optionally, as described with reference to FIGS. 1A and 1B, the interposer 202 can include one or more redistribution layers on the first side, one or more redistribution layers on the second side, or both. Further, although FIGS. 2A and 2B illustrate four electronic devices 204 associated with four photonic devices 206, in other implementations, the device 200 can include more than four or fewer than four electronic devices 204, more than four or fewer than four photonic devices 206, or both. In some implementations, the number of electronic devices 204 is different from the number of photonic devices 206. For example, a single photonic device 206 can be electrically connected, via electrical interconnects 208 and optional redistribution layers to more than one electronic device 204. In such examples, light signals can be addressed in a manner that distinguishes which of the electronic devices 204 a particular light signal is directed to or is sent from. Additionally, or alternatively, different characteristics (e.g., frequency) of the light signals can be used to indicate which of the electronic devices 204 a particular light signal is directed to or is sent from. As another illustrative example, a single electronic device 204 can be electrically connected, via the electrical interconnects 208 and optional redistribution layers, to more than one photonic device 206. To illustrate, in such an example, the electronic device 204A may send electrical signals to the photonic device 206A for communication, via light signals transmitted through optical waveguide 210A, to the electronic device 204B and may send electrical signals to the photonic device 206C for communication, via light signals transmitted through optical waveguide 210B, to the electronic device 204D.

The layers 220-224 of the body of the interposer 202 can be formed as described with reference to FIGS. 1A and 1B with the addition that the regions 230 of the core layer 220 bounding the optical waveguides 210 can undergo further selective processing to define walls of the optical waveguides 210. As a particular example, selective doping and/or selective etching of the core layer 220 can be used to provide different refractive indexes in regions of the core layer 220 corresponding to the optical waveguides 210 and the regions 230 of the core layer 220 bounding the optical waveguides 210.

FIGS. 3A and 3B illustrate aspects of a device 300, which is a particular example of the device 100 of FIGS. 1A and 1B. FIG. 3A illustrates a schematic cross-sectional view of the device 300, and FIG. 3B illustrates a schematic top view of the device 300 of FIG. 3A. The device 300 includes an interposer 302 that includes a core layer 320 and cladding layers 322, 324 on opposing sides of the core layer 320 to define one or more optical waveguides 310. The interposer 302 also includes electrical interconnects 308 that extend through the layers 320-324 to electrically connect electronic devices 304 on a first side of the interposer 302 to photonic devices 306 on a second side of the interposer 302.

In the example illustrated in FIGS. 3A and 3B, the electronic devices 304 include a first electronic device 304A, a second electronic device 304B, a third electronic device 304C, a fourth electronic device 304D, a fifth electronic device 304E, and a sixth electronic device 304F. Further, in FIGS. 3A and 3B, the photonic devices 306 include a first photonic device 306A, a second photonic device 306B, a third photonic device 306C, a fourth photonic device 306D a fifth photonic device 306E, and a sixth photonic device 306F. The electronic devices 304 of FIGS. 3A and 3B are examples of the electronic devices 104 of FIGS. 1A and 1B, and the photonic devices 306 are examples of the photonic devices 106 of FIGS. 1A and 1B.

In FIGS. 3A and 3B, each of the photonic devices 306 is associated with an optical coupler 340 to facilitate communication of light signals between the photonic device 306 and the waveguides 310 defined in the core layer 320. For example, the first photonic device 306A is associated with an optical coupler 340A, the second photonic device 306B is associated with an optical coupler 340B, and the third photonic device 306C is associated with an optical coupler 340C. In some implementations, the optical couplers 340 include optical fibers disposed in grooves or recesses of the interposer 302 and configured to facilitate exchange of light signals between the photonic devices 306 and the waveguides 310. In other examples, other types of optical couplers 340 are used.

In FIGS. 3A and 3B, the core layer 320 and cladding layers 322, 324 together define the optical waveguides 310 within a body of the interposer 302. For example, regions of the core layer 320 corresponding to each waveguide 310 have a refractive index greater than refractive indexes of the cladding layers 322, 324. Further, in FIGS. 3A and 3B, a region 330 of the core layer 320 has a lower refractive index than the regions corresponding to the waveguides 310, thereby distinguishing two or more separate waveguides 310 (e.g., waveguide 310A and waveguide 310B, as shown in FIG. 3B) within the interposer 302.

The layers 320-324 of the body of the interposer 302 can be formed as described with reference to FIGS. 1A and 1B with the addition that the region 330 of the core layer 320 bounding the waveguides 310 can undergo selective processing to define a wall between the waveguides 310. As a particular example, selective doping and/or selective etching of the core layer 320 can be used to provide different refractive indexes in regions of the core layer 320 corresponding to the waveguides 310 and the region 330 of the core layer 320 separating the waveguides 310.

Optionally, as described with reference to FIGS. 1A and 1B, the interposer 302 can include one or more redistribution layers 326 on the first side, one or more redistribution layers 328 on the second side, or both. Further, although FIGS. 3A and 3B illustrate six electronic devices 304 associated with six photonic devices 306, in other implementations, the device 300 can include more than six or fewer than six electronic devices 304, more than six or fewer than six photonic devices 306, or both. In some implementations, the number of electronic devices 304 is different from the number of photonic devices 306.

In the example illustrated in FIGS. 3A and 3B, each waveguide 310 can be used for exchange of light signals by more than two photonic devices 306. For example, the first photonic device 306A can send light signals to the second photonic device 306B, the third photonic device 306C, or both, via the waveguide 310A. To illustrate, a light signal sent from the first photonic device 306A via the waveguide 310A can be received by both the second photonic device 306B and the third photonic device 306C. In this example, the light signal can be addressed in a manner that distinguishes which of the electronic devices 304 the light signal is directed to or different characteristics (e.g., frequency) of the light signals can be used to indicate which of the electronic devices 304 a particular light signals is directed to.

### Exemplary Sequence for Fabricating a Device Including an Interposer Defining an Integrated Optical Waveguide

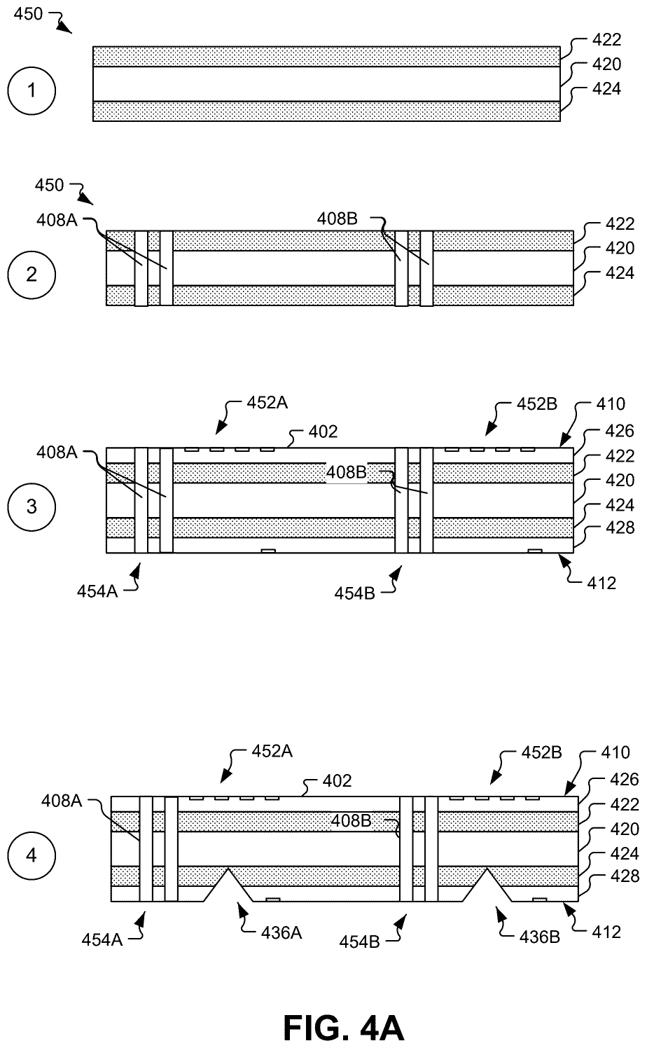

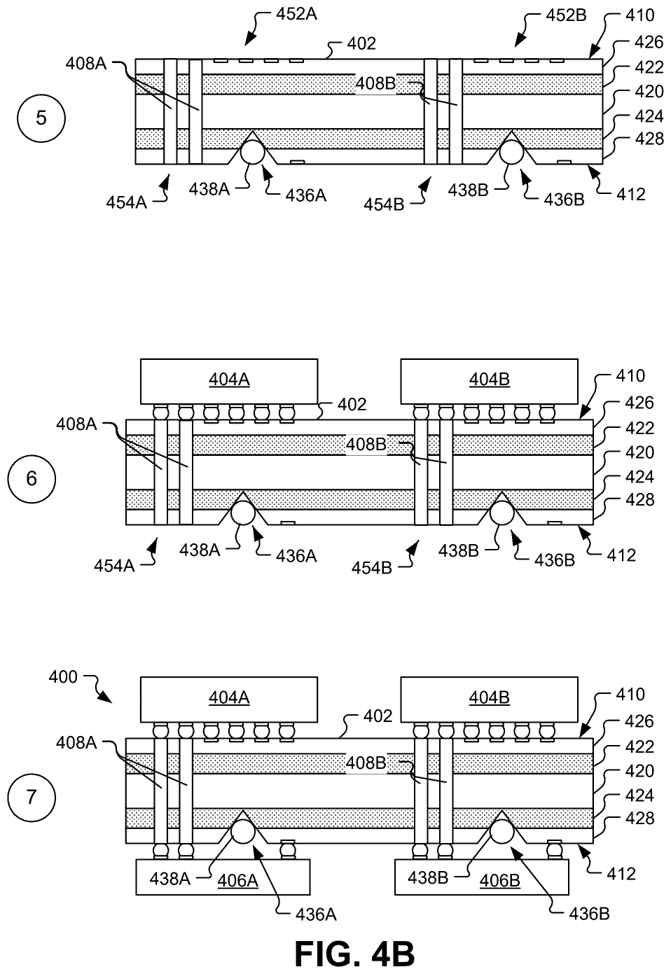

In some implementations, fabricating an integrated device (e.g., any of the devices 100, 200, or 300 of FIGS. 1A-3B) includes several processes. FIGS. 4A and 4B, together, illustrate an exemplary sequence for fabricating an integrated device. In some implementations, the sequence of FIGS. 4A and 4B may be used to provide (e.g., during fabrication of) one or more of the devices 100, 200, or 300 of FIGS. 1A-3B.

It should be noted that the sequence of FIGS. 4A and 4B may combine one or more stages in order to simplify and/or clarify the sequence for providing or fabricating an integrated device. In some examples, the order of the processes may be changed or modified. In some examples, one or more of the processes may be replaced or substituted without departing from the scope of the disclosure. In the following description, reference is made to various illustrative stages of the sequence, which are numbered (using circled numbers) in FIGS. 4A and 4B. Each of the various stages of the sequence illustrated in FIGS. 4A and 4B shows a single device being formed. In other implementations, one or more of the stages can be performed in a manner that forms multiple devices concurrently (e.g., on a carrier or using operations at a wafer-level, a reconstructed wafer-level, a strip-or panel-level, etc.

Stage 1 of FIG. 4A illustrates a state after formation of a body 450 of an interposer (e.g., an interposer 402 illustrated at Stage 3). The body 450 of the interposer includes a plurality of layers, including a core layer 420 and cladding layers 422, 424 on opposing sides of the core layer 420. The core layer 420 can correspond to any of the core layers 120, 220, or 320 as described with reference to FIGS. 1A-3B. Each of the cladding layers 422, 424 has a lower refractive index than the core layer 420 enabling the core layer 420 to act as an optical waveguide, as described above.

In a particular example, formation of the body 450 begins with a monolithic specimen which is processed to change refractive indexes of portions thereof to define the layers 420-424. For example, a silicon specimen can be subjected to one or more porosification etching processes to define the layers 420-424. In one example, a porosifaction etching process includes connecting a silicon specimen as an anode in a circuit and immersing the silicon specimen in a bath of hydrofluoric acid and ethanol. In this example, a current applied between the anode and a cathode (e.g., platinum cathode) causes etching of the silicon specimen in a manner that progresses from outer surfaces of the silicon specimen toward a center of the silicon specimen. By careful process control, the etching can be used to increase the porosity of the outer layers of the silicon specimen relative to the porosity of an inner most layer of the silicon specimen, thereby reducing the refractive index of the outer layers to define the cladding layers 422, 424. In this example, the inner most layer corresponds to the core layer 420.

In another example, formation of the body 450 begins with three distinct specimens which are processed to change refractive indexes thereof to define the three layers 420-424. For example, a first silicon specimen can be subjected to a first porosification etching process (as described above) to define the cladding layer 422, and a second silicon specimen can be subjected to a second porosification etching process to define the cladding layer 424. The core layer 420 can be formed of a third silicon specimen or of a specimen of another material (e.g., silicon nitride). The porosification etching processes can be controlled to provide each layer 420-424 porosity associated with a desired refractive index of the corresponding layer. In this example, after formation of the individual layers 420, 424, the layers 420-424 can be affixed to one another to form the body 450.

In still other examples, the differences in the refractive indexes of the layers 420-424 can be established in some other manner. To illustrate, different concentrations of dopants or different types of dopants can be added to the individual silicon specimens to define the layers 420-424. As another example, different materials can be used to form the layers 420-424. In particular, the core layer 420 can be formed of a different material than the cladding layers 422, 424. To illustrate, the cladding layers 422, 424 can include porous silicon, and the core layer 420 can include silicon nitride.

Further, in examples in which the core layer 420 defines more than one waveguide, such as in the examples illustrated in FIGS. 2A-3B, the core layer 420 can be selectively processed to provide different refractive indexes within different regions of the core layer 420. As one example, before subjecting a silicon specimen to a porosification etch process to form the core layer 420, a silicon nitride masking layer can be formed on selected portions of the silicon specimen. In this example, the silicon nitride masking layer protects underlying regions of the silicon specimen from porosification, resulting in regions of lower porosity and corresponding higher refractive index. In this example, the silicon nitride masking layer can be removed from the silicon specimen before assembly of the body 450.

Stage 2 illustrates a state after formation of conductive interconnects 408 through the body 450 of the interposer. In FIGS. 4A and 4B, the conductive interconnects include one or more conductive interconnects 408A and one or more conductive interconnects 408B. The conductive interconnects 408 can be formed using one or more processes to form through openings in the body 450, such as drilling, selective etching, etc. followed by one or more metal deposition operations, such as plating.

Stage 3 illustrates a state after formation of one or more redistribution layers 426 on a first side 410 of the body 450 and one or more redistribution layers 428 on a second side 412 of the body. In some embodiments, formation of the interposer 402 is complete at Stage 3. The redistribution layers 426, 428 are optional, and redistribution layers 426, 428 can be omitted from one or both of the sides 410, 412. The redistribution layers 426, 428 can be formed using various patterning and deposition processes, such as photolithography, plating, printing, vapor deposition, resin application and spreading, etching, etc.

The redistribution layers 426, 428 enable routing of conductive traces between various contacts 452, 454. The contacts 452 are configured to be electrically connected to corresponding contacts of electronic and/or photonic devices coupled to the first side 410 of the interposer 402, and the contacts 454 are configured to be electrically connected to corresponding contacts of electronic and/or photonic devices coupled to the second side 412 of the interposer 402. In FIG. 4A, the contacts 452 include contacts 452A configured to electrically connect to corresponding contacts of a first electronic device (e.g., first electronic device 404A shown at Stage 6 of FIG. 4B) and contacts 452B configured to electrically connect to corresponding contacts of a second electronic device (e.g., second electronic device 404B shown at Stage 6 of FIG. 4B). In some embodiments, the redistribution layers 426 can also include additional contacts configured to electrically connect the contacts 452A, the contacts 452B, or both, to one or more other devices.

For simplicity of illustration, the conductive interconnects 408 are illustrated in FIGS. 4A and 4B as extending to the first side 410 and the second side 412, however, in some embodiments, the conductive interconnects 408 are electrically connected to conductors of the redistribution layers 426, 428, which provide conductive paths to appropriate ones of the contacts 452. 454. In other embodiments, the operations described with reference to Stages 2 and 3 are reversed. For example, the redistribution layers 426, 428 are formed on the body 450, and the conductive interconnects 408 are formed to extend through the body 450 and the redistribution layers 426, 428.

Stage 4 illustrates a state after formation of grooves 436 (including a groove 436A and a groove 436B) on the second side 412 of the interposer 402 to accommodate optical couplers. One or more selective removal operations can be used to form the grooves 436. For example, one or more sawing, selective etching, or other material removal processes can be used. Although the grooves 436 are illustrated in FIGS. 4A and 4B as having a V-shaped profile, in other examples, the grooves 436 can have a different profile shape depending on the material removal process used to form the grooves 436.

The sequence of FIGS. 4A and 4B illustrates operations to form an integrated device that uses optical fibers in conjunction with couplers, such as edge couplers or grating couplers, to couple the light into the waveguide, as described with reference to FIGS. 1A and 1B. In other embodiments, different types of optical couplers can be used, in which case, formation of the grooves 436 can be omitted or modified to accommodate the specific type of optical couplers used by the integrated device.

Stage 5 of FIG. 4B illustrates a state after optical fibers 438 (including optical fiber 438A and optical fiber 438B) are disposed in the grooves 436 to form optical couplers. In a particular example, each optical fiber is faceted (e.g., beveled in a specific manner) to capture and internally propagate light from a photonic device and to exchange light signals with the core layer 420. Each optical fiber is affixed to a surface of a corresponding groove 436 to maintain the position and orientation of the optical fiber (and its facets) to enable exchange of light signals between a photonic device and the core layer 420.

The order of Stages 6 and 7 illustrated in FIG. 4B is arbitrary and can be reversed. Stage 6 illustrates a state after electronic devices 404 (including a first electronic device 404A and a second electronic device 404B) are electrically connected to the contacts 452 of the interposer 402. In the example illustrated, one or more flip chip die attach operations are used to electrically connect the electronic devices 404 to the interposer 402. For example, reflow of solder balls, solder bumps, or solder caps of pillar bumps can be used to form electrical connections between conductors of the interposer 402 and conductors of the electronic devices 404.

Stage 7 illustrates a state after photonic devices 406 (including a first photonic device 406A and a second photonic device 406B) are electrically connected to the contacts 454 of the interposer 402. In the example illustrated, one or more flip chip die attach operations are used to electrically connect the photonic devices 406 to the interposer 402. For example, reflow of solder balls, solder bumps, or solder caps of pillar bumps can be used to form electrical connections between conductors of the interposer 402 and conductors of the photonic devices 406.

In some embodiments, formation of the integrated device 400 is complete at Stage 7. In other embodiments, one or more additional operations can be performed, such as disposing underfill material between the interposer 402 and any or all of the electronic devices 404, the photonic devices 406, or both. Additionally, or alternatively, further operations can be performed to electrically connect the electronic devices 404, the photonic devices 406, or both, to one or more additional devices of the integrated device 400, to one or more additional devices separate from the integrated device 400, or both.

### Exemplary Flow Diagram of a Method for Fabricating a Device Including an Interposer Defining an Integrated Optical Waveguide

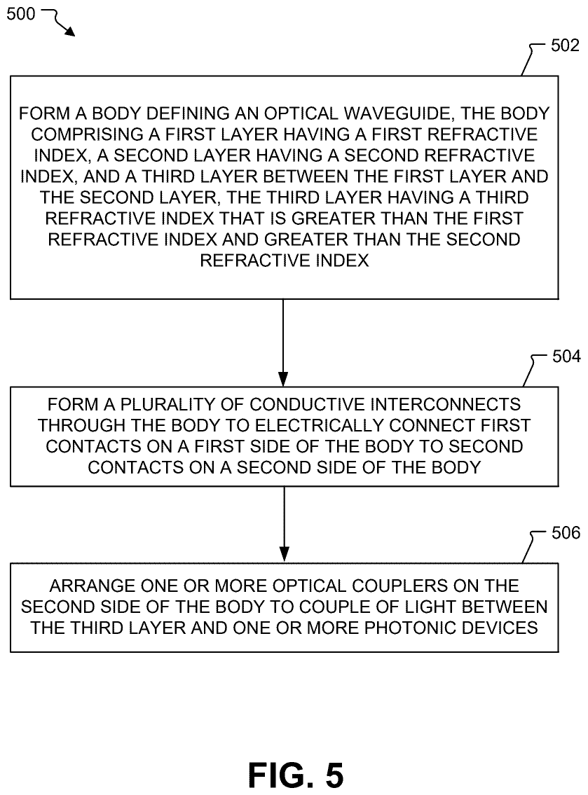

FIG. 5 illustrates an exemplary flow diagram of a method 500 for fabricating a device that includes an interposer defining an integrated optical waveguide. For example, the method 500 can be used to fabricate one or more of the devices 100, 200, or 300 of FIGS. 1A-3B.

The method 500 includes, at block 502, forming a body defining an optical waveguide, the body comprising a first layer having a first refractive index, a second layer having a second refractive index, and a third layer between the first layer and the second layer, the third layer having a third refractive index that is greater than the first refractive index and greater than the second refractive index. Various operations to form the body are described with reference to Stage 1 of FIG. 4A. For example, the body can be formed by obtaining three layers that have appropriate refractive indexes and affixing three layers to one another to form the body. Alternatively, the body can be formed of a monolithic specimen that is selectively processed to form the three layers.

In some embodiments, forming the three layers of the body can include etching a first silicon-based layer to increase porosity of the first silicon-based layer to a porosity associated with the first refractive index to form the first layer, etching a second silicon-based layer to increase porosity of the second silicon-based layer to a porosity associated with the second refractive index to form the second layer, and etching a third silicon-based layer to increase porosity of the third silicon-based layer to a porosity associated with the third refractive index to form the third layer. In some embodiments, the third layer can be processed in a selective manner to define two or more non-intersecting regions having the third refractive index. For example, walls with a fourth refractive index (less than the third refractive index) can be defined in the third layer to distinguish two or more distinct optical waveguides within the body.

In some embodiments, the three layers of the body can be formed using selective doping processes (e.g., by selecting adding refractive index dopants to one or more of the layers. For example, in such embodiments, the method 500 can include doping a first silicon-based layer with a refractive index dopant to form the first layer and doping a second silicon-based layer with a refractive index dopant to form the second layer. Additionally, or alternatively, the method 500 can include doping a third silicon-based layer with a refractive index dopant to form the third layer. The first, second, and third layers can subsequently be stacked and affixed to form the body. In another example, a first region of a silicon-based layer is selectively doped to define the first layer and a second region of a silicon-based layer is selectively doped to define the second layer. In this example, a third region of the silicon-based layer (e.g., an undoped region between the first region and the second region) corresponds to the third layer.

The method 500 includes, at block 504, forming a plurality of conductive interconnects through the body to electrically connect first contacts on a first side of the body to second contacts on a second side of the body. Various operations to form the conductive interconnects through the body are described with reference to Stage 2 of FIG. 4A. For example, conductive interconnects can be formed using etching, drilling, or other selective material removal processes to define openings, and plating or other material deposition processes to deposit conductive materials within the openings.

The method 500 includes, at block 506, arranging one or more optical couplers on the second side of the body to couple light between the third layer and one or more photonic devices. Various operations to couple one or more optical couplers to the body are described with reference to Stages 4 and 5 of FIG. 4A and 4B. For example, in embodiments that use optical fiber-based optical couplers as described with reference to FIGS. 1A and 1B, grooves or recesses can be formed on the second side of the body to retain optical fibers, which can subsequently by affixed in position within the grooves or recesses.

After the body is prepared to receive optical couplers, formation of the interposer is complete. In some cases, the method 500 can also include operations to form a device that includes the interposer. For example, the method 500 can include electrically connecting a first electronic device to a first set of the first contacts and electrically connecting a first photonic device to a first set of the second contacts to define electrical signal paths between the first electronic devices and the first photonic devices. In this example, the first photonic device is arranged relative to a first optical coupler of the one or more optical couplers to enable communication of optical signals between the optical waveguide and the first photonic device. In this example, the method 500 can also include electrically connecting a second electronic device to a second set of the first contacts, and electrically connecting a second photonic device to a second set of the second contacts to define electrical signal paths between the second electronic devices and the second photonic devices. In this example, the second photonic device is arranged relative to a second optical coupler of the one or more optical couplers to enable communication of the optical signals between the first photonic device and the second photonic device via the optical waveguide.

In some examples, the body defines an optical waveguide that can be used by multiple sets of devices for optical communication. In such examples, the method 500 can include electrically connecting a third electronic device to a third set of the first contacts and electrically connecting a third photonic device to a third set of the second contacts to define electrical signal paths between the third electronic devices and the third photonic devices. In this example, the third photonic device is arranged relative to a third optical coupler of the one or more optical couplers to enable communication, via the optical waveguide, of the optical signals between the third photonic device and the first photonic device, the second photonic device, or both.

In some examples, the body defines more than one optical waveguide, such as at least a second optical waveguide. In this example, the method 500 can include electrically connecting a third electronic device to a third set of the first contacts, electrically connecting a third photonic device to a third set of the second contacts to define electrical signal paths between the third electronic devices and the third photonic devices, electrically connecting a fourth electronic device to a fourth set of the first contacts, and electrically connecting a fourth photonic device to a fourth set of the second contacts to define electrical signal paths between the fourth electronic devices and the fourth photonic devices. In this example, the third photonic device is arranged relative to a third optical coupler of the one or more optical couplers and the fourth photonic device is arranged relative to a fourth optical coupler of the one or more optical couplers to enable communication of the optical signals between the third photonic device and the fourth photonic device via the second optical waveguide.

### Exemplary Flow Diagram of a Method of Operation of a Device Including an Interposer Defining an Integrated Optical Waveguide

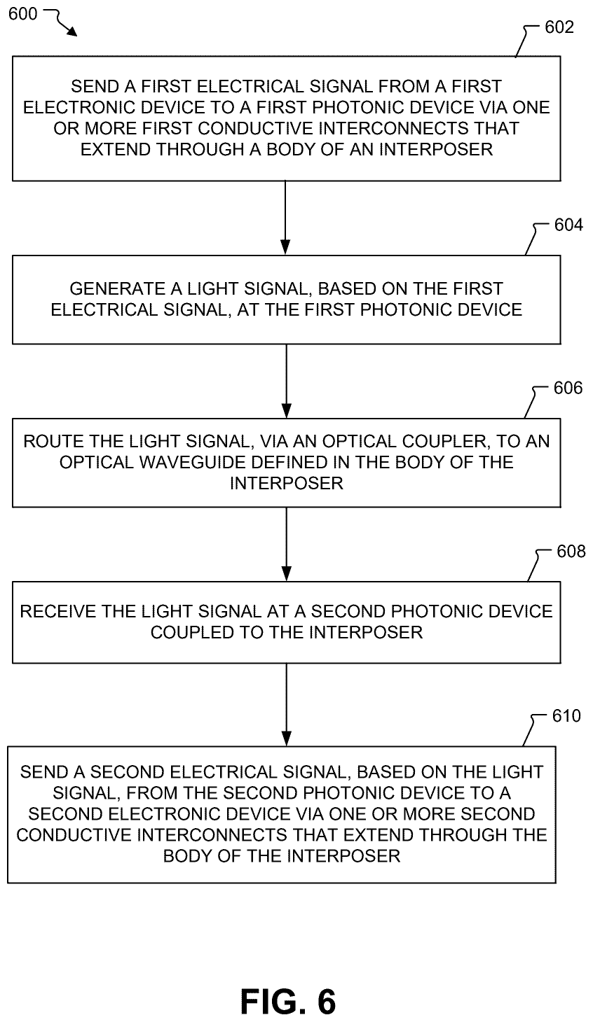

FIG. 6 illustrates an exemplary flow diagram of a method of operation of a device that includes an interposer defining an integrated optical waveguide. For example, the method 600 can be performed during operation of any of the devices 100, 200, or 300 of FIGS. 1A-3B.

The method 600 includes, at block 602, sending a first electrical signal from a first electronic device to a first photonic device via one or more first conductive interconnects that extend through a body of an interposer. For example, the first electronic device 104A of FIGS. 1A and 1B can send electrical signals to the first photonic device 106A via the first conductive interconnects 108A that extend through the body of the interposer 102.

The method 600 also includes, at block 604, generating a light signal, based on the first electrical signal, at the first photonic device. For example, the first photonic device 106A of FIGS. 1A and 1B can generate the light signal 150 based on the electric signals from the first electronic device 104A.

The method 600 includes, at block 606, routing the light signal, via an optical coupler, to an optical waveguide defined in the body of the interposer. For example, the optical fiber 138A of FIGS. 1A and 1B or one of the optical couplers 240A or 340A of FIGS. 2A-3B can route the light signals from the photonic device to the optical waveguide.

The method 600 includes, at block 608, receiving the light signal at a second photonic device coupled to the interposer. For example, the second photonic device 106B of FIGS. 1A and 1B can receive the light signal 150 from the optical waveguide defined by the layers 120-124 of the interposer 102.

The method 600 includes, at block 610, sending a second electrical signal, based on the light signal, from the second photonic device to a second electronic device via one or more second conductive interconnects that extend through the body of the interposer. For example, the second photonic device 106B of FIGS. 1A and 1B can send a second electrical signal, based on the light signal 150, to the second electronic device 104B via the conductive interconnects 108B that extend through the body of the interposer 102.

### Exemplary Electronic Devices

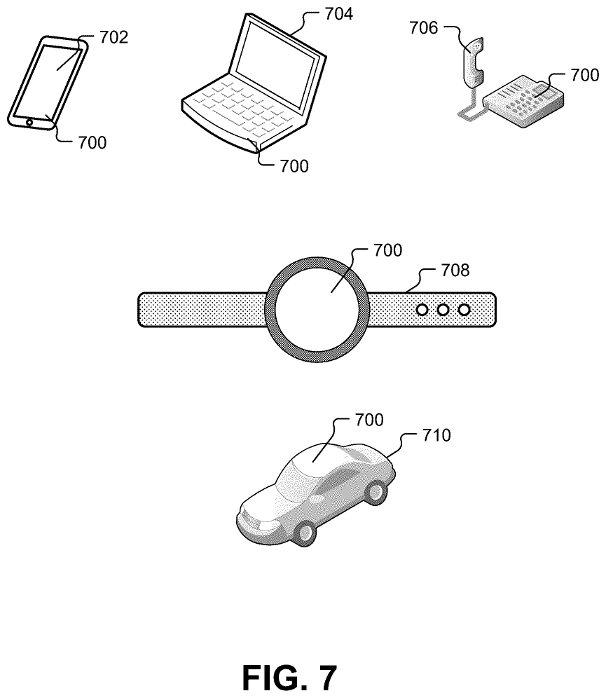

FIG. 7 illustrates various electronic devices that may include or be integrated with the devices 100, 200, 300, 400 of any of FIGS. 1A-4B, or the interposer 102, 202, 302, or 402 of any of FIGS. 1A-4B. For example, a mobile phone device 702, a laptop computer device 704, a fixed location terminal device 706, a wearable device 708, or a vehicle 710 (e.g., an automobile or an aerial device) may include a device 700. The device 700 can include, for example, the any of the interposers 102, 202, 302, or 402 and/or any of the devices 100, 200, 300, or 400 described herein. The devices 702, 704, 706 and 708 and the vehicle 710 illustrated in FIG. 7 are merely exemplary. Other electronic devices may also feature the device 700 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices (e.g., watches, glasses), Internet of things (IoT) devices, servers, routers, electronic devices implemented in vehicles (e.g., autonomous vehicles), or any other device that stores or retrieves data or computer instructions, or any combination thereof.

One or more of the components, processes, features, and/or functions illustrated in FIGS. 1A-7 may be rearranged and/or combined into a single component, process, feature or function or embodied in several components, processes, or functions. Additional elements, components, processes, and/or functions may also be added without departing from the disclosure. It should also be noted FIGS. 1A-7 and its corresponding description in the present disclosure is not limited to dies and/or ICs. In some implementations, FIGS. 1A-7 and the corresponding description may be used to manufacture, create, provide, and/or produce devices and/or integrated devices. In some implementations, a device may include a die, an integrated device, an integrated passive device (IPD), a die package, an integrated circuit (IC) device, a device package, an integrated circuit (IC) package, a wafer, a semiconductor device, a package-on-package (POP) device, a heat dissipating device and/or an interposer.

It is noted that the figures in the disclosure may represent actual representations and/or conceptual representations of various parts, components, objects, devices, packages, integrated devices, integrated circuits, and/or transistors. In some instances, the figures may not be to scale. In some instances, for purpose of clarity, not all components and/or parts may be shown. In some instances, the position, the location, the sizes, and/or the shapes of various parts and/or components in the figures may be exemplary. In some implementations, various components and/or parts in the figures may be optional.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling (e.g., mechanical coupling) between two objects. For example, if object A physically touches object B, and object B touches object C, then objects A and C may still be considered coupled to one another-even if they do not directly physically touch each other. An object A, that is coupled to an object B, may be coupled to at least part of object B. The term “electrically coupled” may mean that two objects are directly or indirectly coupled together such that an electrical current (e.g., signal, power, ground) may travel between the two objects. Two objects that are electrically coupled may or may not have an electrical current traveling between the two objects. The use of the terms “first”, “second”, “third” and “fourth” (and/or anything above fourth) is arbitrary. Any of the components described may be the first component, the second component, the third component or the fourth component. For example, a component that is referred to as a second component, may be the first component, the second component, the third component or the fourth component. The terms “encapsulate”, “encapsulating” and/or any derivation means that the object may partially encapsulate or completely encapsulate another object. The terms “top” and “bottom” are arbitrary. A component that is located on top may be located over a component that is located on a bottom. A top component may be considered a bottom component, and vice versa. As described in the disclosure, a first component that is located “over” a second component may mean that the first component is located above or below the second component, depending on how a bottom or top is arbitrarily defined. In another example, a first component may be located over (e.g., above) a first surface of the second component, and a third component may be located over (e.g., below) a second surface of the second component, where the second surface is opposite to the first surface. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. A first component that is located “in” a second component may be partially located in the second component or completely located in the second component. A value that is about X-XX, may mean a value that is between X and XX, inclusive of X and XX. The value(s) between X and XX may be discrete or continuous. The term “about ‘value X’”, or “approximately value X”, as used in the disclosure means within 10 percent of the ‘value X’. For example, a value of about 1 or approximately 1, would mean a value in a range of 0.9-1.1. A “plurality” of components may include all the possible components or only some of the components from all of the possible components. For example, if a device includes ten components, the use of the term “the plurality of components” may refer to all ten components or only some of the components from the ten components.

In some implementations, an interconnect is an element or component of a device or package that allows or facilitates an electrical connection between two points, elements and/or components. In some implementations, an interconnect may include a trace, a via, a pad, a pillar, a metallization layer, a redistribution layer, and/or an under-bump metallization (UBM) layer/interconnect. In some implementations, an interconnect may include an electrically conductive material that may be configured to provide an electrical path for a signal (e.g., a data signal), ground and/or power. An interconnect may include more than one element or component. An interconnect may be defined by one or more interconnects. An interconnect may include one or more metal layers. An interconnect may be part of a circuit. Different implementations may use different processes and/or sequences for forming the interconnects. In some implementations, a chemical vapor deposition (CVD) process, a physical vapor deposition (PVD) process, a sputtering process, a spray coating, and/or a plating process may be used to form the interconnects.

Also, it is noted that various disclosures contained herein may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed.

In the following, further examples are described to facilitate the understanding of the disclosure.

According to Example 1, a device includes an interposer having a first side and a second side. The interposer includes an optical waveguide defined in a region between the first side and the second side; first contacts on the first side configured to be electrically connected to one or more electronic devices; second contacts on the second side configured to be electrically connected to one or more photonic devices; conductive interconnects electrically connecting one or more of the first contacts to one or more of the second contacts; and an optical coupler on the second side configured to enable coupling of light between the one or more photonic devices and the optical waveguide.

Example 2 includes the device of Example 1, wherein the optical waveguide is a planar waveguide.

Example 3 includes the device of Example 1 or Example 2, wherein the optical waveguide is defined by at least a first cladding layer having a first refractive index, a second cladding layer having a second refractive index, and a core layer, between the first cladding layer and the second cladding layer, having a third refractive index, and wherein the third refractive index is greater than the first refractive index and is greater than the second refractive index.

Example 4 includes the device of Example 3, wherein the optical waveguide is further defined by one or more cladding walls between the first cladding layer and the second cladding layer.

Example 5 includes the device of Example 3 or Example 4, wherein the first cladding layer, the second cladding layer, and the core layer comprise silicon.

Example 6 includes the device of any of Examples 3 to 5, wherein the first cladding layer has a first porosity, the second cladding layer has a second porosity, and the core layer has a third porosity, wherein the third porosity is less than the first porosity and is less than the second porosity.

Example 7 includes the device of any of Examples 3 to 6, wherein the first cladding layer, the second cladding layer, the core layer, or a combination thereof, further comprise a refractive index dopant.

Example 8 includes the device of any of Examples 3 to 7, wherein the first cladding layer and the second cladding layer comprise silicon and the core layer comprises silicon nitride.

Example 9 includes the device of any of Examples 1 to 8, wherein the optical coupler includes an optical fiber disposed in a groove on the second side of the interposer, the optical fiber having a first end configured to exchange light signals with a photonic device of the one or more photonic devices and a second end configured to exchange light signals with the optical waveguide.

According to Example 10, a device includes an interposer having a first side and a second side; a first electronic device coupled to the first side of the interposer; a second electronic device coupled to the first side of the interposer; a first photonic device coupled to the second side of the interposer; and a second photonic device coupled to the second side of the interposer. The interposer includes an optical waveguide defined in a region between the first side and the second side; first conductive interconnects electrically connecting the first electronic device and the first photonic device; second conductive interconnects electrically connecting the second electronic device and the second photonic device; a first optical coupler on the second side configured to enable coupling of light between the first photonic device and the optical waveguide; and a second optical coupler on the second side configured to enable coupling of light between the second photonic device and the optical waveguide.

Example 11 includes the device of Example 10, wherein the first photonic device is configured to receive first electrical signals from the first electronic device via the first conductive interconnects; and send light signals based on the first electrical signals to the second photonic device, via the first optical coupler, the optical waveguide, and the second optical coupler.

Example 12 includes the device of Example 10 or Example 11, wherein the second photonic device is configured to receive the light signals from the photonic device via the second optical coupler; and send second electrical signals based on the light signals to the second electronic device via the first conductive interconnects.

Example 13 includes the device of any of Examples 10 to 12, wherein the optical waveguide is a planar waveguide.

Example 14 includes the device of any of Examples 10 to 13, wherein the optical waveguide is defined by at least a first cladding layer having a first refractive index, a second cladding layer having a second refractive index, and a core layer, between the first cladding layer and the second cladding layer, having a third refractive index, and wherein the third refractive index is greater than the first refractive index and is greater than the second refractive index.

Example 15 includes the device of Example 14, wherein the optical waveguide is further defined by one or more cladding walls between the first cladding layer and the second cladding layer.

Example 16 includes the device of Example 14 or Example 15, wherein the first cladding layer, the second cladding layer, and the core layer comprise silicon.

Example 17 includes the device of any of Examples 14 to 16, wherein the first cladding layer has a first porosity, the second cladding layer has a second porosity, and the core layer has a third porosity, wherein the third porosity is less than the first porosity and is less than the second porosity.

Example 18 includes the device of any of Examples 14 to 17, wherein the first cladding layer, the second cladding layer, the core layer, or a combination thereof, further comprise a refractive index dopant.

Example 19 includes the device of any of Examples 14 to 18, wherein the first cladding layer and the second cladding layer comprise silicon and the core layer comprises silicon nitride.

Example 20 includes the device of any of Examples 10 to 19, wherein the first optical coupler, the second optical coupler, or both, are configured to exchange light signals with a respective photonic device.

Example 21 includes the device of any of Examples 10 to 20 and further includes one or more redistribution layers on the first side of the interposer configured to form conductive paths between the first electronic device, the second electronic device, or both, and one or more third electronic devices.

According to Example 22, a method of fabrication includes forming a body defining an optical waveguide, the body comprising a first layer having a first refractive index, a second layer having a second refractive index, and a third layer between the first layer and the second layer, the third layer having a third refractive index that is greater than the first refractive index and greater than the second refractive index; forming a plurality of conductive interconnects through the body to electrically connect first contacts on a first side of the body to second contacts on a second side of the body; and arranging one or more optical couplers on the second side of the body to couple light between the third layer and one or more photonic devices.

Example 23 includes the method of Example 22 and further includes electrically connecting a first electronic device to a first set of the first contacts; and electrically connecting a first photonic device to a first set of the second contacts to define electrical signal paths between the first electronic devices and the first photonic devices, wherein the first photonic device is arranged relative to a first optical coupler of the one or more optical couplers to enable communication of optical signals between the optical waveguide and the first photonic device.

Example 24 includes the method of Example 22 or Example 23 and further includes electrically connecting a second electronic device to a second set of the first contacts; and electrically connecting a second photonic device to a second set of the second contacts to define electrical signal paths between the second electronic devices and the second photonic devices, wherein the second photonic device is arranged relative to a second optical coupler of the one or more optical couplers to enable communication of the optical signals between the first photonic device and the second photonic device via the optical waveguide.

Example 25 includes the method of Example 24, wherein the body further defines a second optical waveguide, and the method further includes electrically connecting a third electronic device to a third set of the first contacts; and electrically connecting a third photonic device to a third set of the second contacts to define electrical signal paths between the third electronic devices and the third photonic devices; electrically connecting a fourth electronic device to a fourth set of the first contacts; and electrically connecting a fourth photonic device to a fourth set of the second contacts to define electrical signal paths between the fourth electronic devices and the fourth photonic devices, wherein the third photonic device is arranged relative to a third optical coupler of the one or more optical couplers and the fourth photonic device is arranged relative to a fourth optical coupler of the one or more optical couplers to enable communication of the optical signals between the third photonic device and the fourth photonic device via the second optical waveguide.

Example 26 includes the method of Example 24 and further includes electrically connecting a third electronic device to a third set of the first contacts; and electrically connecting a third photonic device to a third set of the second contacts to define electrical signal paths between the third electronic devices and the third photonic devices, wherein the third photonic device is arranged relative to a third optical coupler of the one or more optical couplers to enable communication, via the optical waveguide, of the optical signals between the third photonic device and the first photonic device, the second photonic device, or both.

Example 27 includes the method of any of Examples 22 to 26 and further includes forming the first layer including etching a first silicon-based layer to increase porosity of the first silicon-based layer to a porosity associated with the first refractive index; forming the second layer including etching a second silicon-based layer to increase porosity of the second silicon-based layer to a porosity associated with the second refractive index; and forming the third layer by etching a third silicon-based layer to increase porosity of the third silicon-based layer to a porosity associated with the third refractive index.

Example 28 includes the method of any of Examples 22 to 27 and further includes forming the third layer including processing a silicon-based layer to selectively adjust refractive indices of portions of the silicon-based layer to define two or more non-intersecting regions having the third refractive index.

Example 29 includes the method of any of Examples 22 to 28 and further includes forming the first layer including doping a first silicon-based layer with a refractive index dopant; and forming the second layer including doping a second silicon-based layer with a refractive index dopant.

Example 30 includes the method of any of Examples 22 to 29, wherein forming the body comprises affixing the first layer to a first side of the third layer and affixing the second layer to a second side of the third layer.

Example 31 includes the method of any of Examples 22 to 28, wherein forming the body includes selectively doping a first region of a silicon-based layer to define the first layer; and selectively doping a second region of the silicon-based layer to define the second layer, wherein the third layer corresponds to a third region of the silicon-based layer between the first region and the second region.

According to Example 32, a method includes sending a first electrical signal from a first electronic device to a first photonic device via one or more first conductive interconnects that extend through a body of an interposer; generating a light signal, based on the first electrical signal, at the first photonic device; routing the light signal, via an optical coupler, to an optical waveguide defined in the body of the interposer; receiving the light signal at a second photonic device coupled to the interposer; and sending a second electrical signal, based on the light signal, from the second photonic device to a second electronic device via one or more second conductive interconnects that extend through the body of the interposer.

Example 33 includes the method of Example 32, wherein the interposer includes the interposer of any of Examples 1 to 9.

The various features of the disclosure described herein can be implemented in different systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. A device comprising:
an interposer having a first side and a second side, the interposer comprising:
an optical waveguide defined in a region between the first side and the second side;
first contacts on the first side configured to be electrically connected to one or more electronic devices;
second contacts on the second side configured to be electrically connected to one or more photonic devices;
conductive interconnects electrically connecting one or more of the first contacts to one or more of the second contacts; and
an optical coupler on the second side configured to enable coupling of light between the one or more photonic devices and the optical waveguide.

2. The device of claim 1, wherein the optical waveguide is defined by at least a first cladding layer having a first refractive index, a second cladding layer having a second refractive index, and a core layer, between the first cladding layer and the second cladding layer, having a third refractive index, and wherein the third refractive index is greater than the first refractive index and is greater than the second refractive index.

3. The device of claim 2, wherein the optical waveguide is further defined by one or more cladding walls between the first cladding layer and the second cladding layer.

4. The device of claim 2, wherein the first cladding layer, the second cladding layer, and the core layer comprise silicon.

5. The device of claim 4, wherein the first cladding layer has a first porosity, the second cladding layer has a second porosity, and the core layer has a third porosity, wherein the third porosity is less than the first porosity and is less than the second porosity.

6. The device of claim 4, wherein the first cladding layer, the second cladding layer, the core layer, or a combination thereof, further comprise a refractive index dopant.

7. The device of claim 1, wherein the optical coupler includes an optical fiber disposed in a groove on the second side of the interposer, the optical fiber having a first end configured to exchange light signals with a photonic device of the one or more photonic devices and a second end configured to exchange light signals with the optical waveguide.

8. A device comprising:
an interposer having a first side and a second side;
a first electronic device coupled to the first side of the interposer;
a second electronic device coupled to the first side of the interposer;
a first photonic device coupled to the second side of the interposer; and
a second photonic device coupled to the second side of the interposer,
wherein the interposer comprises:
an optical waveguide defined in a region between the first side and the second side;
first conductive interconnects electrically connecting the first electronic device and the first photonic device;
second conductive interconnects electrically connecting the second electronic device and the second photonic device;
a first optical coupler on the second side configured to enable coupling of light between the first photonic device and the optical waveguide; and
a second optical coupler on the second side configured to enable coupling of light between the second photonic device and the optical waveguide.

9. The device of claim 8, wherein the first photonic device is configured to:
receive first electrical signals from the first electronic device via the first conductive interconnects; and
send light signals based on the first electrical signals to the second photonic device, via the first optical coupler, the optical waveguide, and the second optical coupler.

10. The device of claim 9, wherein the second photonic device is configured to:
receive the light signals from the photonic device via the second optical coupler; and
send second electrical signals based on the light signals to the second electronic device via the first conductive interconnects.

11. The device of claim 8, wherein the optical waveguide is defined by at least a first cladding layer having a first refractive index, a second cladding layer having a second refractive index, and a core layer, between the first cladding layer and the second cladding layer, having a third refractive index, and wherein the third refractive index is greater than the first refractive index and is greater than the second refractive index.

12. The device of claim 11, wherein the optical waveguide is further defined by one or more cladding walls between the first cladding layer and the second cladding layer.

13. The device of claim 8, wherein the first optical coupler, the second optical coupler, or both, are configured to exchange light signals with a respective photonic device.

14. The device of claim 8, further comprising one or more redistribution layers on the first side of the interposer configured to form conductive paths between the first electronic device, the second electronic device, or both, and one or more third electronic devices.

15. A method of fabrication comprising:
forming a body defining an optical waveguide, the body comprising a first layer having a first refractive index, a second layer having a second refractive index, and a third layer between the first layer and the second layer, the third layer having a third refractive index that is greater than the first refractive index and greater than the second refractive index;
forming a plurality of conductive interconnects through the body to electrically connect first contacts on a first side of the body to second contacts on a second side of the body; and
arranging one or more optical couplers on the second side of the body to couple light between the third layer and one or more photonic devices.

16. The method of claim 15, further comprising:
electrically connecting a first electronic device to a first set of the first contacts; and
electrically connecting a first photonic device to a first set of the second contacts to define electrical signal paths between the first electronic device and the first photonic device, wherein the first photonic device is arranged relative to a first optical coupler of the one or more optical couplers to enable communication of optical signals between the optical waveguide and the first photonic device.

17. The method of claim 16, further comprising:
electrically connecting a second electronic device to a second set of the first contacts; and
electrically connecting a second photonic device to a second set of the second contacts to define electrical signal paths between the second electronic device and the second photonic device, wherein the second photonic device is arranged relative to a second optical coupler of the one or more optical couplers to enable communication of the optical signals between the first photonic device and the second photonic device via the optical waveguide.

18. The method of claim 17, wherein the body further defines a second optical waveguide, and the method further comprises:
electrically connecting a third electronic device to a third set of the first contacts; and
electrically connecting a third photonic device to a third set of the second contacts to define electrical signal paths between the third electronic device and the third photonic device;
electrically connecting a fourth electronic device to a fourth set of the first contacts; and
electrically connecting a fourth photonic device to a fourth set of the second contacts to define electrical signal paths between the fourth electronic device and the fourth photonic device, wherein the third photonic device is arranged relative to a third optical coupler of the one or more optical couplers and the fourth photonic device is arranged relative to a fourth optical coupler of the one or more optical couplers to enable communication of the optical signals between the third photonic device and the fourth photonic device via the second optical waveguide.

19. The method of claim 17, further comprising:
electrically connecting a third electronic device to a third set of the first contacts; and
electrically connecting a third photonic device to a third set of the second contacts to define electrical signal paths between the third electronic device and the third photonic device, wherein the third photonic device is arranged relative to a third optical coupler of the one or more optical couplers to enable communication, via the optical waveguide, of the optical signals between the third photonic device and the first photonic device, the second photonic device, or both.

20. The method of claim 15, wherein forming the body comprises affixing the first layer to a first side of the third layer and affixing the second layer to a second side of the third layer.
